(19) United States
(12) Patent Application Publication
(10) Pub. No.: US 2009/0006142 A1
(43) Pub. Date: Jan. 1, 2009

(54) System and Method for Tracking Spending Based on Reservations and Payments

(75) Inventors: Mark ORTTUNG, Menlo Park, CA (US); Aaron GRECO, Belmont, CA (US); Tamar LOWELL, Oakland, CA (US); Patrick NEWMAN, Palo Alto, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: REARDEN COMMERCE, INC., Foster City, CA (US)

(21) Appl. No.: 11/768,882

(22) Filed: Jun. 26, 2007

(51) Int. Cl. G06Q 10/00; G06Q 40/00

(52) U.S. Cl. 705/5; 705/39

(57) ABSTRACT

One embodiment provides a method, that may be implemented on a system for obtaining a schedule of bookings made by a user through an electronic service portal; obtaining a schedule of payment transactions to pay for bookings, the payment transactions comprising one or more of a credit card payment, a cash payment, or a payment via a cash card or debit card; and using the schedule of bookings made via the electronic service portal to identify payment transactions reimbursable to the user from a separate entity and generating an expense report of the reimbursable payment transactions.

### BACKGROUND OF THE INVENTION

Often, when employees are issued a company credit card, it happens that, for various reasons, the statement for this credit card comes directly to the employee. Thus, in such cases, employees need to incorporate those charges into their expense reports and submit the expense reports. Such an arrangement is usually to provide legal protection for the credit card issuer and the employer in cases of dispute over the personal financial responsibility for charges on the credit card. However, it is an undue burden on the employee to whom the card is issued, and a corresponding burden on the company's employee efficiency rates, to require an employee to manually transfer expenses from one statement to another statement.

Also, an employee may have more than one credit card, to cover situations where one card is not accepted. For example, many companies issue an American Express card, but there may be cases where the employee incurs a business expense at an establishment that does not accept American Express, so he must then charge that expense to his personal credit card or pay in cash. At the time the employee prepares his expense report, he may not clearly recall all his expenses on all his credit cards, and he may thus end up subsidizing his employer. Likewise, the company records do not then reflect their true expenditures for various classes of employee expenses, causing faulty conclusions and projections about their cost of doing business going forward.

What is clearly needed is a system and method to reconcile transactions for services made with reservations, including calendar knowledge, using an electronic services portal, and the financial transactions to pay for those services.

### DESCRIPTION OF THE EMBODIMENTS

The disclosure is illustrated by way of example and not limitation in the figures of the accompanying drawings in which like references indicate similar elements

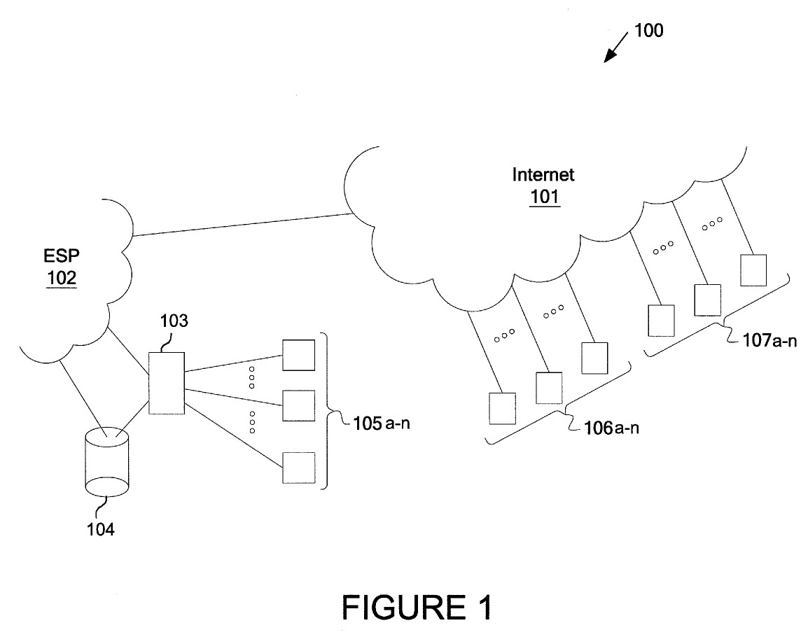

FIG. 1 shows an exemplary overview of a system 100 according to one embodiment of the current invention;

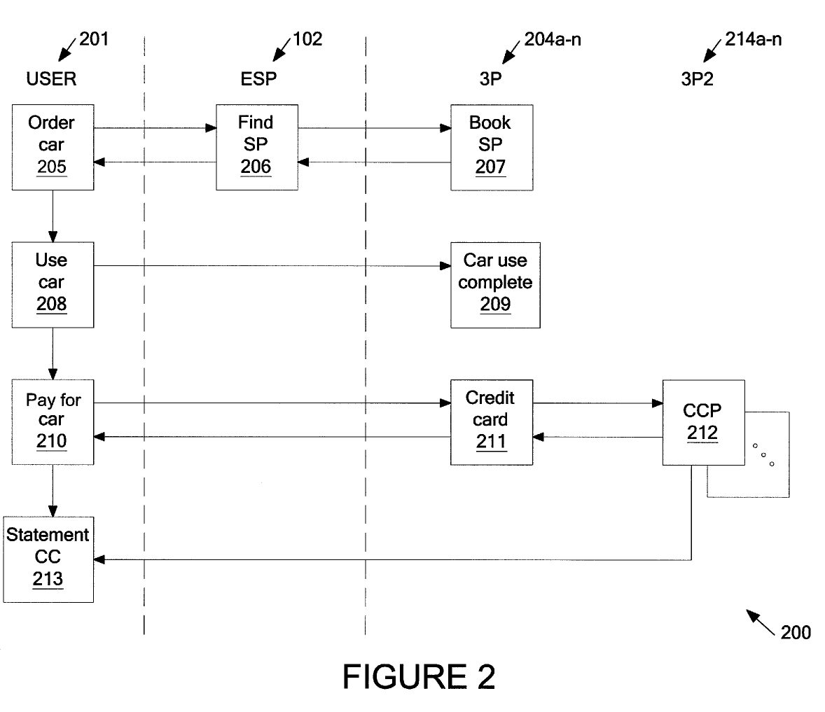

FIG. 2 shows an exemplary time diagram of a typical services portal transaction 200 according to one embodiment of the current invention;

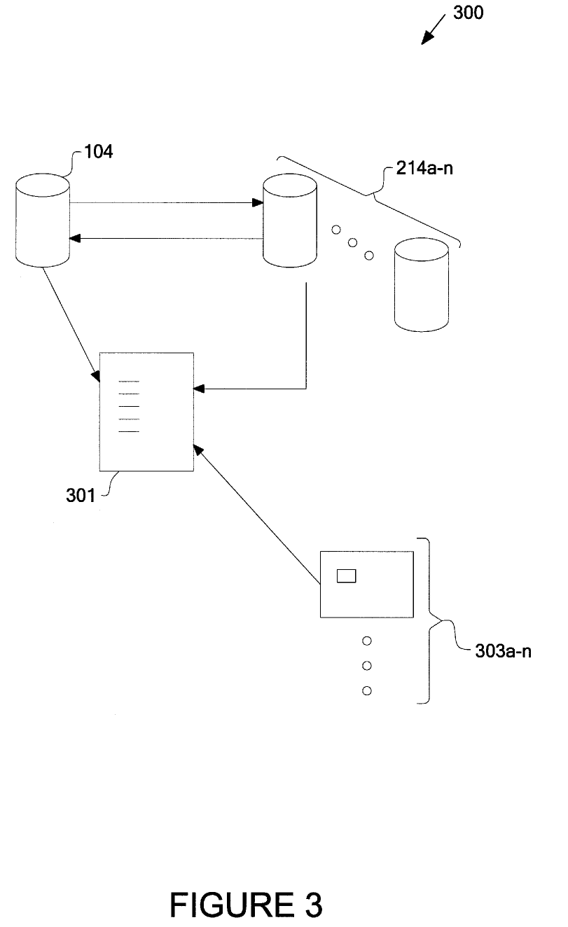

FIG. 3 shows an exemplary overview of a transaction 300; and

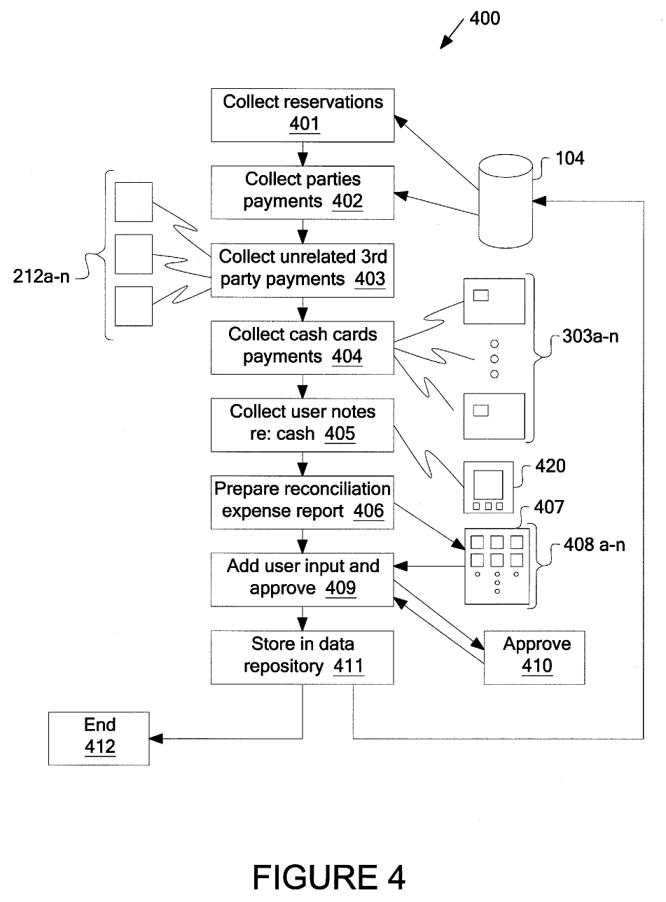

FIG. 4 shows an exemplary process 400 for reconciling expense records according to one embodiment of the present invention.

### SUMMARY

Some embodiments of the present invention are summarized in this section.

One embodiment provides a method, that may be implemented on a system for obtaining a schedule of bookings made by a user through an electronic service portal; obtaining a schedule of payment transactions to pay for bookings, the payment transactions comprising one or more of a credit card payment, a cash payment, or a payment via a cash card or debit card; and using the schedule of bookings made via the electronic service portal to identify payment transactions reimbursable to the user from a separate entity and generating an expense report of the reimbursable payment transactions.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

FIG. 1 shows an exemplary overview of a system 100 according to one embodiment of the current invention. An electronic services portal ESP 102 connects to a server 103 and a database 104. The server hosts several software instances 105a-n, which, depending on the implementation of the system, may be one, several, or many instances. These software instances are to be considered only exemplary indications of how the software could be installed in server 103 and how it could work in conjunction with ESP 102, personal information managers (PIMs, not shown) including electronic calendars, and main data repository 104. System 101 connects via Internet 101 to system users 106a-n and suppliers 107a-n. It is clear that these connections could also be through direct connection, through a phone system, or through any other suitable networking method, known or to be invented.

FIG. 2 shows an exemplary time diagram of a typical services portal transaction 200 according to one embodiment of the current invention. Three columns, left to right, show the three parties in an exemplary transaction over time. These parties are the user 201, the electronic services portal ESP 102, and third-party vendors 204a-n, and third-party payer-provider 214a-n. In FIG. 2, the passage of time is shown proceeding from top to bottom in each column, with processes taken by the various parties proceeding horizontally (processes of interactions among the parties) and top-to-bottom (sequential processes by one party). In process 205, a user places an order to rent a car service, for example. In process 206, ESP 102 receives the order and finds a provider of car services.

In process 207, the user reviews the offer by the car provider. He books the car and receives confirmation of the booking. All these processes occur during one time interval. In process 208, the user later employs the car service, as shown in process 209, where the car picks up the user at his departure point and drives the user to one or more destination points. When the user is finished using the car service, he pays for the service in process 210 by any of various means, including but not limited to billing to an open account or presenting a voucher, a code number, a credit card, or cash. For example, in process 211 the user gives a credit card to the driver at the end of the period of car service. The driver verifies the card with the credit card company, which, in process 212, confirms the authenticity of the card. Later the user receives a credit card statement in process 213. It is later used to close the loop on this transaction.

FIG. 3 shows an exemplary overview of a transaction 300. Main repository 104 contains all the bookings, which are put into a list 301. The items in this list are then combined with records of financial transactions (e.g., earlier-mentioned statement containing said transactions) from service providers 214a-n and additional cash payments 303a-n. Cash services could be, for example, transacted using cash chips that are used in many places for phones, for parking, for small transactions in hotels, vending machines, etc. Or these could be records of actual cash transactions, said records being stored in the memory of a portable device, for example, such as a PDA or any other similar device on which a user may record his cash transactions. This combining of various data sources allows a more complete expense report to be compiled, without requiring as much user input and manual transcription of different reports into a single expense report.

FIG. 4 shows an exemplary process 400 for reconciling expense records according to one embodiment of the present invention. In process 401, data about service reservations is collected from data repository 104. In process 402, data about open account payments are collected, also from data repository 104. In process 403, data about unrelated or loosely related third-party payments, such as those billed by credit card companies and other partners 214a-n are collected. These charges can typically be obtained online within 24 hours of them being incurred, often before the credit card company bills them. In process 404, data about cash card payments 303a-n are collected. These may, for example, require a reader, or in other cases, cash card companies may send a statement that can be parsed and integrated into the process.

Additionally, in some cases, unassigned expenses could be pre-assigned based on the transaction location and/or time stamp and matching events in the PIM calendar, following a time-line. Billed transactions often do not show the correct day, as all transaction of a business are typically finalized on the next business day, so a variance for that must be allowed. In process 405, data about hard cash transactions are collected from storage repositories such as, for example, a user's PDA 420. It is clear that there may be many different means and methods for collecting such information. For example, a user could enter data about each transaction in his calendar, and a special form would allow him to designate this data as a service transaction. Or in other cases, for example, software could be installed on a PDA, or some software might already exist on the PDA, such as, for example, PocketQuicken™. This software could be used to collect data about actual cash transactions. In other cases, the user may manually enter these expenses.

In process 406 a reconciliation report 407 could be prepared for the user, which report would contain many fields 408a-n. These fields have been reconciled in the report, but in process 409 the user may review them, modify any fields as he desires, and ultimately approve the report. The report is then sent for approval in process 410, according to company policies for required managerial or accounting department approvals. In process 411, the approved report returns and is stored in data repository 104, and the process moves to process 412, where it ends. Data from old reports may have many uses, such as, for example, improving understanding of the needs of employees during expensed trips and events. Additional services providers may be included in contracts to offer services, or particular providers, that are not currently available under contract. In other cases, information from reports may be used to predict cash expenses that are not currently included in the system. These expenses may then be included in the reconciliation report as an anticipated expense, based on past behavior of the user, reducing the need for the user to manually enter missing transactions, as he now does in process 405 or process 409. Although some aspects of this invention, such as automatic bill payments, are currently well known, they have not been previously included in a mixed-transaction system for compiling expense reports.

It is clear that the information gathered by the system according to this invention may have many other uses. It is also clear that many modifications and variations of this embodiment may be made by one skilled in the art without departing from the spirit of the novel art of this disclosure. These modifications and variations do not depart from the broader spirit and scope of the invention, and the examples cited here are to be regarded in an illustrative rather than a restrictive sense.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

In the foregoing specification, the disclosure has been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

What is claimed is:

1. A computer-implemented method comprising:
obtaining a schedule of bookings made by a user through an electronic service portal;
obtaining a schedule of payment transactions to pay for bookings, the payment transactions comprising one or more of a credit card payment, a cash payment, or a payment via a cash card or debit card; and
using the schedule of bookings made via the electronic service portal to identify payment transactions reimbursable to the user from a separate entity and generating an expense report of the reimbursable payment transactions.

2. The computer-implemented method of claim 1, wherein the bookings by the user through the electronic service portal are related to services performed by the user for the separate entity.

3. The computer-implemented method of claim 2, wherein the entity is an employer of the user.

4. The computer-implemented method of claim 2, wherein the obtaining a schedule of payment transactions to pay for bookings, further comprises obtaining one or more payment transactions from a portable device on to which the user manually records transactions.

5. The computer-implemented method of claim 2, wherein the obtaining a schedule of payment transactions to pay for bookings, further comprises obtaining a schedule of credit card payment transactions.

6. The computer-implemented method of claim 2, wherein the electronic service portal has access to a calendar of the user.

7. The computer-implemented method of claim 2, wherein the calendar comprises a travel schedule of the user.

8. The computer-implemented method of claim 2, further comprising providing user access to the report in a modifiable form.

9. The computer-implemented method of claim 8, further comprising submitting the expense report to the separate entity for approval in accordance with a set of predetermined criteria.

10. A machine-readable medium having stored thereon a set of instructions which when executed perform a method comprising:
obtaining a schedule of bookings made by a user through an electronic service portal;
obtaining a schedule of payment transactions to pay for bookings, the payment transactions comprising one or more of a credit card payment, a cash payment, or a payment via a cash card or debit card; and
using the schedule of bookings made via the electronic service portal to identify payment transactions reimbursable to the user from a separate entity and generating an expense report of the reimbursable payment transactions.

11. The machine-readable medium of claim 10, wherein the bookings by the user through the electronic service portal are related to services performed by the user for the separate entity.

12. The machine-readable medium of claim 11, wherein the entity is an employer of the user.

13. The machine-readable medium of claim 11, wherein the obtaining a schedule of payment transactions to pay for bookings, further comprises obtaining one or more payment transactions from a portable device on to which the user manually records transactions.

14. The machine-readable medium of claim 11, wherein the obtaining a schedule of payment transactions to pay for bookings, further comprises obtaining a schedule of credit card payment transactions.

15. The machine-readable medium of claim 11, wherein the electronic service portal has access to a calendar of the user.

16. The machine-readable medium of claim 11, wherein the calendar comprises a travel schedule of the user.

17. The machine-readable medium of claim 11, further comprising providing user access to the report in a modifiable form.

18. The machine-readable medium of claim 17, further comprising submitting the expense report to the separate entity for approval in accordance with a set of predetermined criteria.

19. A system comprising:
a means for obtaining a schedule of bookings made by a user through an electronic service portal;
a means for obtaining a schedule of payment transactions to pay for bookings, the payment transactions comprising one or more of a credit card payment, a cash payment, or a payment via a cash card or debit card; and
a means for using the schedule of bookings made via the electronic service portal to identify payment transactions reimbursable to the user from a separate entity and generating an expense report of the reimbursable payment transactions.

20. The system of claim 19, wherein the bookings by the user through the electronic service portal are related to services performed by the user for the separate entity.
